(19) United States
(12) Patent Application Publication
(10) Pub. No.: US 2014/0098296 A1
(43) Pub. Date: Apr. 10, 2014

(54) METHOD AND APPARATUS FOR CHANGING A PERSPECTIVE OF A VIDEO

(71) Applicant: ATI TECHNOLOGIES ULC, Markham (CA)

(72) Inventors: Jitesh Arora, Markham (CA); Cheng He, Oshawa (CN); Jianfei Ye, Richmond Hill (CA); Mir Ahsan, Toronto (CA)

(73) Assignee: ATI Technologies ULC, Markham (CA)

(21) Appl. No.: 13/645,066

(22) Filed: Oct. 4, 2012

(51) Int. Cl. H04N 9/74

(52) U.S. Cl. 348/580; 348/E09.055

(57) ABSTRACT

A method and apparatus provides for changing a perspective of a video such as a display perspective of an object displayed in the video. In one example, the method and apparatus changes the display perspective of an object displayed in the video based on information indicating an orientation and/or position of the recording device that captures the object on the video. To do so, the method and apparatus may determine a current display perspective for an object displayed in the video based on information indicating an orientation and/or position of the recording device. By comparing the current display perspective to a desired display perspective for the object, the method and apparatus determines an amount of display perspective adjustment for the object and selects appropriate perspective adjustment methods to carry out the adjustment. Accordingly, the display perspective adjustment is made to the video automatically for the object displayed in the video without user intervention.

### BACKGROUND

The disclosure relates generally to methods and apparatus for changing a perspective of a video.

In a video, a captured object is displayed with a perspective, i.e. an orientation and position of the object as displayed in the video. The perspective of the object displayed by a display system of the video can vary depending on the recording device's position and/or orientation relative to the object. For example, the object may be displayed in a front view such that the front side object is fully exposed in the video. In that case, the recording device capturing the object on the video may be directly facing the front side of the object when capturing the object. In another example, the object may be displayed in a side view such that a side of the object is fully exposed. In that case, the recording device capturing the object on the video may be at a position facing the side of the object.

For many video applications, preferred display perspectives for objects of interest captured on the video exist. For example, in applications like video communication, a preferred display perspective of a presenting party captured by a recording device may be such that the presenting party should generally look natural to one or more observing parties of the video, i.e. the presenting party appears in the video in a front view as though looking at the observing parties eye to eye. With such a naturalistic view of the presenting party in the video, the presenting party's communicative expressions, e.g. facial expressions, emotions, etc, can be correctly and quickly observed by the observing parties and hence resulting in effective communication.

In remote video medical diagnosis applications, preferred display perspective of an object of interest in the video can depend on the type of medical diagnosis being performed through the video. For example, if the diagnosis is about the condition and degree of a patient fractured arm and shoulder, a diagnosing doctor may wish to view the patients arm from an angle such that the side of the patient's arm, where the patient reports the arm is fractured, is fully exposed.

However, due to various form factors and physical constraints, a recording device cannot always be placed in a position and orientation to capture an object such that the object is displayed with a desired display perspective in the video. Form factors, i.e. the size and shape of a recording device, may affect a display perspective of the object when the recording device is embedded as a component of an apparatus. For example, a recording device, e.g. camera, may be embedded in a computer monitor or web TV, and the embedded recording device's position and/or orientation may not be adjusted easily to capture a naturalistic view of a presenter without adjusting the position of the computer or web TV. With the advancements in portable computing, video communication is increasingly performed by portable devices equipped with embedded cameras like tablets or smart phones. However, these portable devices are often placed on a table either well below the eye level of a presenter or laid flat on the table. As a result, the display perspective of the presenter will not present a naturalistic view of the presenter in the video.

In some other situations, the recording device may not be easily stabilized to capture the object on the video without jitters. Alternatively, an object itself may be moving around to a degree that the recording device cannot capture it on the video without jitters. As a result, the display perspective of the object so captured changes unnecessarily, and often such changes in display perspective are not desired.

In yet other situations, constraints in physical conditions of an object may also prevent an object from being captured on the video with a desired perspective. For example, in the above-described scenario of medical diagnosis via video, the patient's physical injuries may be particularly acute such that the patient cannot move about the arm freely to expose the arm. Consequently, the patient may not be able to rotate the arm and expose the bottom of the arm towards the recording device due to the injuries. In that case, if the recording device cannot be re-positioned by someone else other than the patient, a side view of the patient's fractured arm may only be captured on the video.

In an obvious solution, multiple recording devices can be positioned around an object of interest from different angles and positions such that the object is captured with more than one perspective on the video. However, this solution requires technical knowledge of how to position the multiple recording devices, which is typically not possessed by an average user of a video application. Moreover, placing multiple recording devices to capture the object adds cost in requiring multiple recording devices and software that switches among multiple perspectives captured by the multiple recording devices.

Some software applications can change an image perspective by using image geometric transformation methods, such as, rotating, shifting, flipping operations, etc. Generally, these methods can adjust a perspective of an object displayed in an image by rotating and shifting the object captured on the image along the x-y-z panel with respect to a reference point to result in a desired display perspective for the object in the image. Such software applications may also employ object reconstruction techniques that allow a user to adjust the perspective freely while creating a more accurate representation of the object by reconstructing the object based on graphical information extracted from related images of the object.

Google Maps™ is one example of such software applications. With Google Maps™, a user can display a location on the map in an image of street view and change the perspective of the street view by, for example, rotating a building displayed in the image. However, the Google Maps™ image perspective transformation approach requires intervention from the user, e.g mouse clicking and dragging. To change a perspective of the street view in Google Maps™, the user must first know how to change the perspective of the image, e.g. to what direction a building should be rotated to achieve a desired display perspective of the building. With that knowledge, the user then must manually change the display perspective of the building on the image. Accordingly, the Google Maps™ techniques are impractical for a user to change a perspective of an object captured on a video. Under the Google Maps™ approach, the user of a video would have to manually change a perspective of an image captured on each frame of the video in order to effect a desired perspective adjustment, because the Google Maps™ techniques are only applicable to still images, i.e. an equivalent of a frame in a video, and requires user's intervention to change the display perspective of the images. Thus, the Google Maps™ techniques would add tremendous inconvenience for the user to change a perspective of an object captured on the video.

In yet another solution, object recognition, e.g. facial recognition, techniques have been developed to detect an object displayed in the video. Some applications using such techniques can provide image stabilization captured on a video (i.e. reducing shake) and can also zoom in and focus on the object upon detection of the object. However, these applications do not adjust a display perspective of the object displayed in the video.

Hence, for one or more of the above-noted problems, there is a need for an enhanced method and apparatus for changing a perspective of displayed video.

### BRIEFED DESCRIPTION OF THE DRAWING

The embodiments will be more readily understood in view of the following description when accompanied by the below figures and wherein like reference numerals represent like elements, wherein:

FIG. 1 is a block diagram illustrating one example of an apparatus for changing a perspective of a video in accordance with one embodiment set forth in the disclosure;

FIG. 2 is a block diagram illustrating the apparatus for changing a perspective of a video shown in FIG. 1;

FIG. 3 is a flowchart illustrating one example of a method for changing a perspective of a video;

FIG. 4 is a flowchart illustrating another example of a method for changing a perspective of a video;

FIG. 5 is a flowchart illustrating still another example of a method for changing a perspective of a video; and

FIGS. 6-7 are exemplary illustrations of changing a perspective of a video.

### DETAILED DESCRIPTION

Briefly, a method and apparatus for adjusting a perspective of a video changes a display perspective of an object displayed in a video based on received information indicating an orientation and/or position of a recording device that captures the object on the video. A display perspective of an object in the video can be an orientation of the object relative to a reference point in the video. For example, the object may be displayed with a perspective such that its front side faces a reference point in the video at a 45 degree angle along the X, Y or Z-Axis. The display perspective of an object in a video may also include a position of the object relative to the reference point in the video. For example, the object may be displayed with a perspective such that it is located at a position having x and y coordinates with respect to the reference point in the video. Often a display perspective of an object in a video is a combination of its orientation and position relative to the reference point, e.g. the object is displayed at a (x,y) position with respect to the center of the video with its front side facing the center at a 45 degree along the X-Z plane. The orientation and/or position of the recording device capturing the object may include angles and distances between the recording device and the object. The recording device may be, for example but not limited to, a video camera, camcorder, webcam, tablet, smart phone, or any other suitable device that can produce motion images for an object captured.

Among other advantages, the method and apparatus provides an ability to adjust a display perspective for an object displayed in a video automatically so that the object is displayed in a desired display perspective on the video without a user's manual adjustment. Instead of requiring the user to determine a current display perspective of the object displayed in the video, determine an amount of display perspective adjustment for the object and physically carry out the adjustment, the method and apparatus adjusts the display perspective for the object displayed in the video intelligently and automatically according to a desired display perspective for the object as defined. Accordingly, the method and apparatus can provide a desired display perspective of an object captured on the video with less user action and thereby improving user's experience in viewing the object displayed in the video.

The method and apparatus may also determine a current display perspective for an object displayed in a video. The current display perspective may be determined based on an orientation of the recording device, e.g., the placement and direction of the recording device relative to the object being captured in a three dimensional (3-D) space. The current display perspective of an object may be a position of the object displayed in the video, for example, the x, y coordinates of the object with respect to a reference point in the video. The current display perspective may also include an orientation of the object displayed in the video with respect to the reference point.

In one example, the method and apparatus changes the display perspective for an object displayed in the video by determining an amount of display perspective adjustment to be made for the object in the video based on the current display perspective of the object. According to the determined amount of display perspective adjustment, the method and apparatus further selects one or more display perspective adjustment methods, such as geometric image manipulation, perspective transformation, and object reconstruction techniques to carry out the adjustment. The method and apparatus then changes the display perspective of the object displayed in the video by the determined amount of the perspective adjustment using the selected display perspective adjustment methods.

In another example, the method and apparatus makes a determination of the amount of display perspective adjustment based on configuration information that configures at least one property of perspective adjustment to be made. Such properties may include identification of an object class whose display perspective may be adjusted in the video. Such properties may also include specification of a desired display perspective for an object class to be displayed in the video. An identification of object class may be a general characterization of a type object, for example, the face of a presenter, a building, a body part of a patient or any other suitable identification information associated with an object of interest captured on a video as generally known in the art. A specification of a desired perspective of the object class may include a description of the desired orientation and/or position of the object class to be displayed in the video.

In yet another example, the method and apparatus changes a display perspective of a face displayed in a video captured by one or more recording devices. The method and apparatus may determine a current display perspective of the face displayed in the video by detecting the face using one or more facial recognition methods as generally known in the art. For example, the method and apparatus may change the display perspective of the face in the video based on a naturalistic view of a presenter in the video. In a naturalistic view, the presenter should generally look natural to one or more observing parties.

In still another example, the apparatus and method may also embed the orientation information of the recording device in the video captured by the recording device as metadata. The method and apparatus may then transmit the video to a target device, which obtains the orientation information of the recording device by extracting the metadata from the transmitted video.

Also among other advantages, the method and apparatus provides an optimal display perspective for an object displayed in a video without adjusting the orientation and/or the position of the recording device that captures the video. Thus, the display perspective of the object can be transformed with minimum user interaction. This improved technique particularly benefits video applications wherein repositioning the recording device is difficult. Accordingly, the method and apparatus improves user's viewing experience of a video when a recording device that captures the video is not positioned optimally to produce a desired display perspective for the object and the position of recording device cannot be adjusted conveniently.

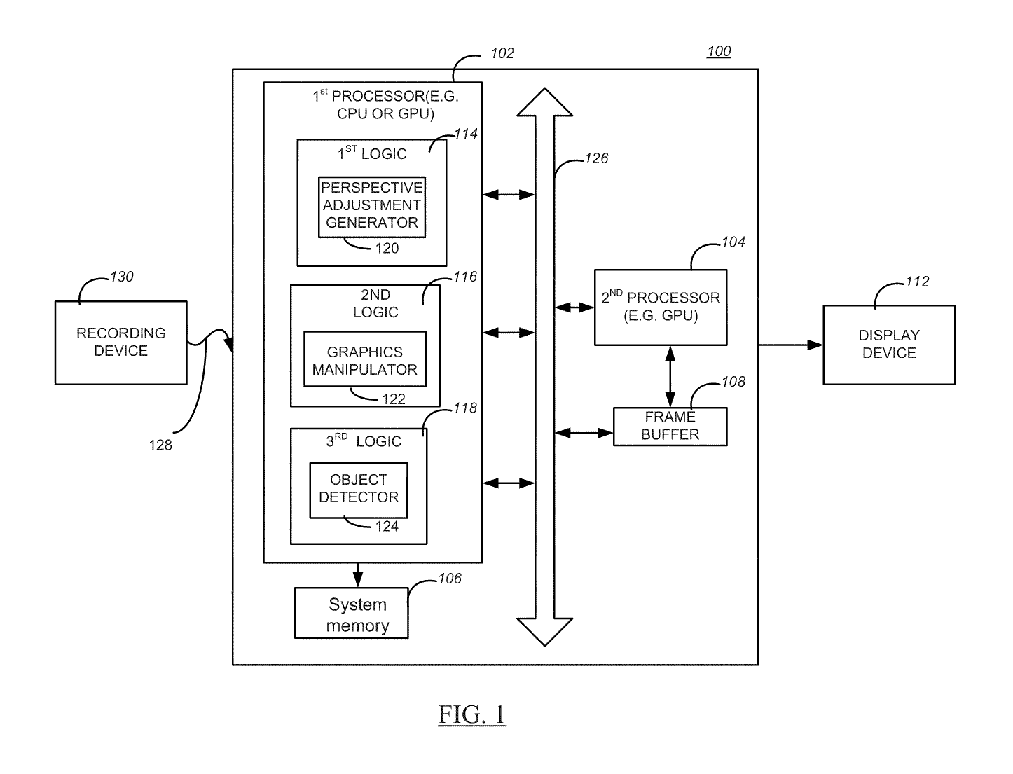

FIG. 1 illustrates an example of an apparatus which is adapted to change a perspective of a video. The apparatus 100 may be any suitable device, for example, a laptop computer, desktop computer, media center, handheld device (e.g., mobile or smart phone, tablet, etc.), Blu-Ray™ player, gaming console, set top box, printer or any other suitable device, to name a few. In this example, the apparatus 100 employs a display device 112, a first processor 102, operatively connected to a system memory 106, a second processor 104 operatively connected to a frame buffer 108, and data buses or point to point connections, such as system bus 126, which transfer data between each structure of the apparatus 100. The apparatus 100 may also include recording device 130, such as a video camera, camcorder, webcam, desktop computer, laptop, web TV, tablet, smart phone or any other suitable device that can capture an object and produce motion electronic motion picture for the object. Any other suitable structure, such as but not limited to a storage device or a controller, may also be included in the apparatus 100.

In this example, the first processor 102 may be a host central unit (CPU) having multiple cores however any suitable processor may be employed including a DSP, APU, GPGPU or any suitable processor or logic circuitry or graphics processing unit (GPU). In this example, the processor 102 is bi-directionally connected to other components of the apparatus 100 via the system bus 108 as generally known in the art, or any other suitable processor. The second processor 104 may be another GPU, which drives the display device 112 via the display. It is understood that, in some other examples of apparatus 100, the first processor (e.g., the CPU or GPU) 102 may be integrated with the second processor 104 to form a general processor. In addition, although the system memory 106 and the frame buffer 108 are shown in FIG. 1 as discrete memory devices, it is also understood that a unified memory architecture that can accommodate all the processors may also be employed in some other examples of apparatus 100.

In this example, as shown, the first processor 102 employs first logic 114 having a perspective adjustment generator 120, second logic 116 having a graphics manipulator 122, and third logic 118 having a object detector. The logic 114, 116, 118 referred to herein is any suitable executing software module, hardware, executing firmware or any suitable combination thereof that can perform the desired function, such as programmed processors, discrete logic, for example, state machine, to name a few. It is further understood that the logic 114, 116, 118 may be included in the first processor 102 as part of the first processor 102, or a discrete component of the apparatus 100 that can be executed by the first processor 102, such as software programs stored on computer readable storage medium that can be loaded into the apparatus 100 and executed by the processor 102. It is also understood that the logic 114, 116, 118 may be combined in some other examples to form an integrated logic that performs desired functions of the logic 114, 116, 118 as described herein. The logic 114, 116, 118 may communicate with structures in the apparatus 100 such as but not limited to the recording device 130, the system memory 106, the frame buffer 108 and the second processors 104.

The apparatus may also include a recording device, such as the recording device 130 as shown in this example. As noted above, the recording device may be any suitable device that can capture an object and produce electronic (e.g. digital or analog) motion pictures for the object, such as but not limited to a video camera, camcorder, webcam, desktop computer, laptop, web TV, tablet, smart phone or any other suitable recording device. It is understood in other examples the number of the recording device 130 included in apparatus 100 may vary and the apparatus 100 may include any desired number of the recording device 130. As shown, the recording device 130 is operatively connected to the other structure of the apparatus 100 via a connection 128. The connection 128 may be a suitable wired connection, such as but not limited to, universal serial bus (USB), analog connectors, for example, composite video, S-Video, VGA, digital connectors, for example, HDMI, mini-DVI, micro-DVI. In other example, the connection 128 may also be a network connection via networks (e.g., satellite links, personal area network, local area network, wide area network, etc.) or any suitable wired or wireless connections as generally known in the art. It is understood that, although only one apparatus 100 is shown in FIG. 1, multiple apparatus may be applied to employ the recording device 130.

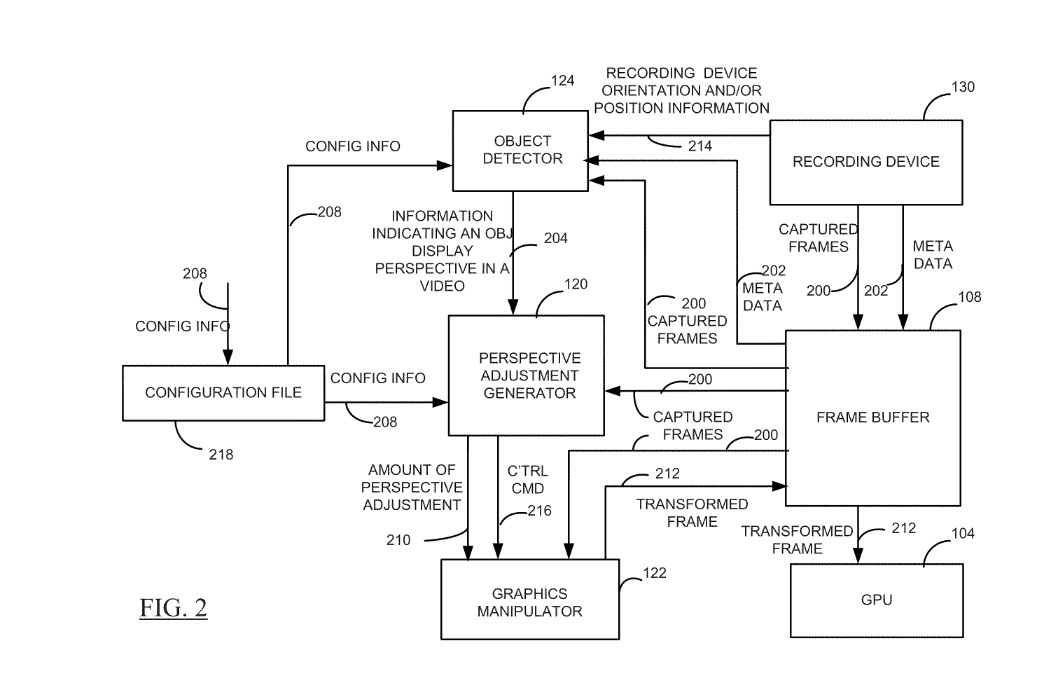

FIG. 2 illustrates further aspects on the exemplary apparatus 100 for changing a perspective of a video. The apparatus 100 includes the logic 114 having perspective adjustment generator 120, the logic 116 having the graphics manipulator 122 and the logic 118 having the object detector 124. In some other examples, it is understood that the perspective adjustment generator 120, the graphics manipulator 122 and object detector 124 may be combined to form an integrated logic running on the processor 102.

In this example, also shown, the recording device 130 is operative to capture an object on a video and transmit video through captured frames 200 to the frame buffer 108. As noted above, the recording device 130 may be integrated in apparatus 100 and operatively connected to other structure of apparatus 100 via any suitable system connection such as the system bus 126. The recording device 130 may also be a remote recording device that is operatively coupled to the apparatus 100 via networks (e.g., personal area network, local area network, wide area network, etc.) or any suitable wired or wireless connections as generally known in the art. As also shown, the recording device 130 in this example is operative to embed metadata 202, e.g. general information regarding the video such as date, place, and time of the video. The metadata 202 may also include orientation and/or position information of the recording device 130, e.g. polar coordinates (r,θ,φ) of the recording device with respect to the object of interest being captured. The metadata 202 may also include position information of the recording device 130 in a 3-D space, e.g. Cartesian coordinates (x,y,z) with respect to the object of interest being captured. In this example, the recording device 130 may also communicate its orientation and/or position information 214 to other structures of the apparatus of 100, e.g. the perspective adjustment generator 120, via system connection such as the system bus 126 through the system memory 106.

In this example, the object detector 124 is operative to determine one or more current display perspectives for an object displayed in a video captured by the recording device 130 based on the information 214 indicating the orientation and/or the position of recording device 214. The object detector 124 receives the captured frames 124 from the frame buffer 108 via the system bus 128 or any other suitable connection as generally known in the art. For each received frame, based on the orientation and/or position information 208 regarding the recording device 130, the object detector 124 may use graphics analysis method as generally known in the art to determine a current display perspective of the object of interest captured in the frame by, for example, obtaining a position and/or orientation of the object with respect to a reference point, e.g. the center of the recording device's lens. As a result, the object detector 124 obtains the information 204 indicating the object's current display perspective in the frame, i.e. the object's position, e.g. Cartesian coordinates (x,y,z), and/or the orientation, e.g. polar coordinates (r,θ,φ), in a 3-D space with respect to a reference point, e.g. the center of the frame. As noted above, the information 214 indicating the orientation and/or position of the recording device 130 may also be embedded in the video or in the video stream (e.g., in an auxiliary data channel/field) as metadata 202 and may be received by the object detector 124 through the frame buffer 108 along with the captured frames comprising the video.

In this example, the object detector 124 may also receive configuration information 208 that configures one or more properties of the object detector 124. For example, the configuration information 208 may include information identifying an object class whose presence and display perspective need to be determined by the object detector 124. The identification of an object class may be a text description of a type of an object, for example, presenter's face, patient's arm, license plate of a vehicle etc, or an image (still or video) of an object class. Those having ordinary skill in the art will appreciate identification information of an object class to enable a detection and/or determination of an object's presence in an image as generally known in the art. Additionally, the configuration information 208 may include information about more than one object.

As shown, the configuration information 208 may be stored in a configuration file 218. The configuration file 208 may also be a dedicated log file kept in a storage device operatively coupled to the CPU 116, or a database that stores configuration setting and options by the OS 210, such as Windows Registry on the Microsoft Windows™ OS.

In this example, the perspective adjustment generator 120 is operative to change the display perspective of the object displayed in the video based on the determined current display perspective of the object displayed in the video, e.g. information 204 indicating the object's position and/or orientation in every frame of the video captured by the recording device 130, provided by the object detector 124. As shown, the perspective adjustment generator 120 receives information 204 from the object detector 124. In this example, the perspective adjustment generator 120 may also receive captured frames of the video from the frame buffer 108 in order to determine the amount of display perspective for the object to be made in one or more of such frames. It is understood that perspective adjustment generator 120 may not need to receive captured frames from the frame buffer to make this determination and in other examples perspective adjustment generator 120 may obtain information regarding one or more captured frames of the video from the object detector 124, the recording device 130, the system memory 106 or any other suitable structure that can provide such information.

The perspective adjustment generator 120 may also receive configuration information 208, which may be used to configure one or more properties of display perspective generator 106. It is understood that the configuration information 208 may be received during the configuration stage of the perspective adjustment generator 120 (e.g. build time or boot time), or during run time of the perspective adjustment generator 120. One type of information the configuration information 208 may include is specification of one or more desired display perspectives for an object class identified. For example, for a video wherein a presenter is captured, the configuration information 208 may specify the following: the presenter's face in the video should be displayed at the center of video, the presenter's face should have a front view in the video and the presenter's eye level should remain at 0 degree along the Z-Axis with respect to the center of the video. As noted above, the configuration information 208 may be stored in the configuration file 218.

In this example, the perspective adjustment generator 120 is also operative to select one or more display perspective adjustment methods according to the determined amount of display perspective adjustment. The display perspective adjustment methods may include graphics geometric manipulation methods, such as but not limited to, geometric transformation (e.g. moving an image up, down, left and right, rotating, shifting, etc), perspective transformation (e.g. an operation that corrects perspective distortion), transposing, warping, etc or any other suitable operations that manipulate graphics geometrically as generally known in the art. For example, a graphics geometric manipulation method may relocate pixels composing an object from their (x,y) spatial coordinates in the source image to new coordinates such that the display perspective of the object is changed in the image. The display perspective adjustment methods may also include object reconstruction methods, such as but not limited to, interpolation, projection, iterative reconstruction, etc or any other suitable operations that reconstruct a part or whole of an object in an image as generally known in the art. For example, in a video communication application, if a presenter is captured and displayed on the video in a side view, the presenter can be displayed in a front view by using an object reconstruction method to reconstruct the presenter's font side based on past frames where the presenter's front side was captured.

In this example, the configuration information 208 may also be used to indicate one or more preferences for using the display perspective adjustment methods. For example, the configuration information 208 may indicate a predetermined order of object reconstruction techniques to be used, e.g., based on their requirement of processing power—i.e. the least processor intensive reconstruction method should be used first to achieve a determined amount of perspective adjustment for the video, then the less processor intensive reconstruction techniques, and so on so forth. The configuration information 208 may also indicate which perspective adjustment method to be used if one or more perspective adjustment methods may achieve an amount of adjustment determined. For example, to rotate an object along a reference point, an affine operation and as well as a rotation operation can be used. In that case, configuration 208 may configure the perspective adjustment generator 120, for example, to use an affine operation to rotate an object along a reference point in the video. It is understood that the above-mentioned configurations are presented for the purposes of exemplary and description only and not by limitation. Any suitable configurations that the configuration information 208 configures the perspective adjustment generator may be appreciated by those having ordinary skill in the art.

In this example, the display perspective is further operative to generate one or more control commands 216 instructing the graphics manipulator 122 to carry out the determined amount of perspective adjustment 210 using the selected perspective adjustment methods. The control command 216 may be any suitable instructions or signals the graphics manipulator 122 recognizes to change a display perspective for an object. For example, the control command 216 may instruct the graphics manipulator to “rotate the object 45 degrees along a reference point in the image using an affine operation”.

In this example, the graphics manipulator 122 is operative to change a perspective of the video according to the determined amount of display perspective adjustment to be made for the object displayed in the video using selected perspective adjustment methods, as instructed by the perspective adjustment generator 120. The graphics manipulator 122 manipulates the image of one or more frames of the video based on such instructions sent by the perspective adjustment generator 120. The graphics manipulator 120 may change every pixel of the image from an original position to a destination position in the image according to the instruction, e.g. applying an rotating operation along the reference point to every pixel in the frame, to generate a transformed frame. The transformed frame 212 is stored in the frame buffer 108 to be further processed by the GPU 104.

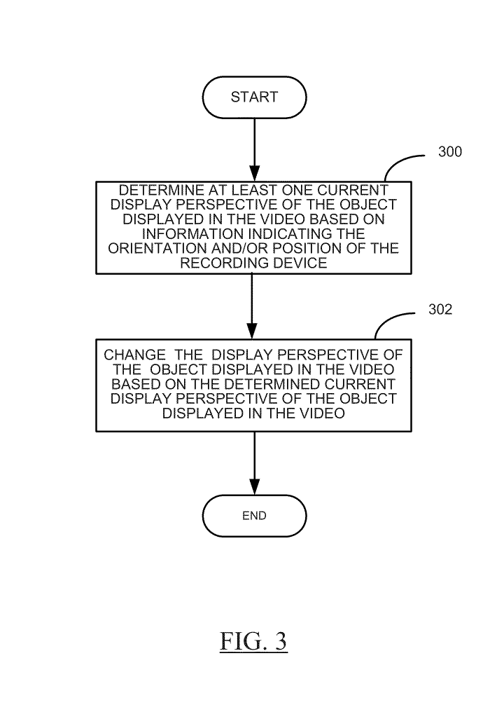

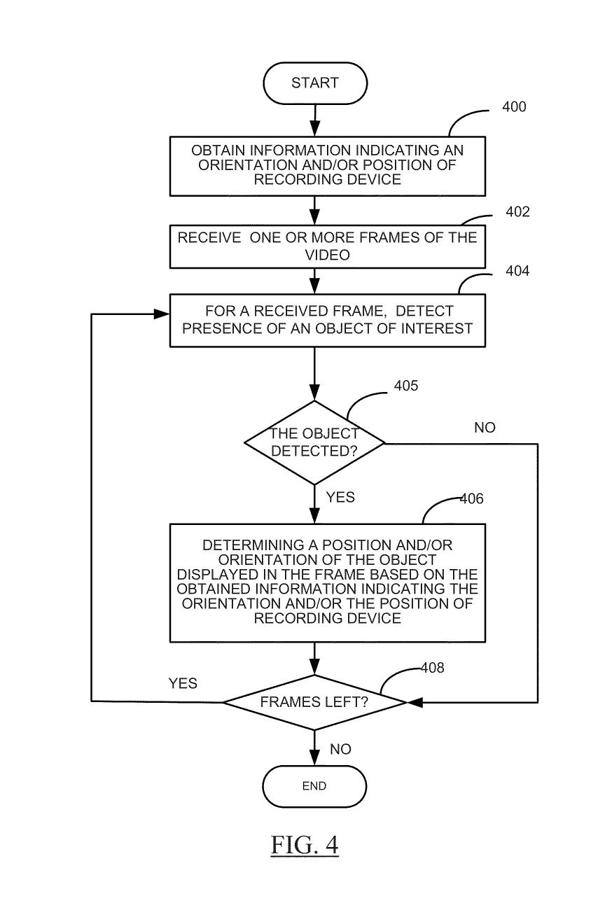

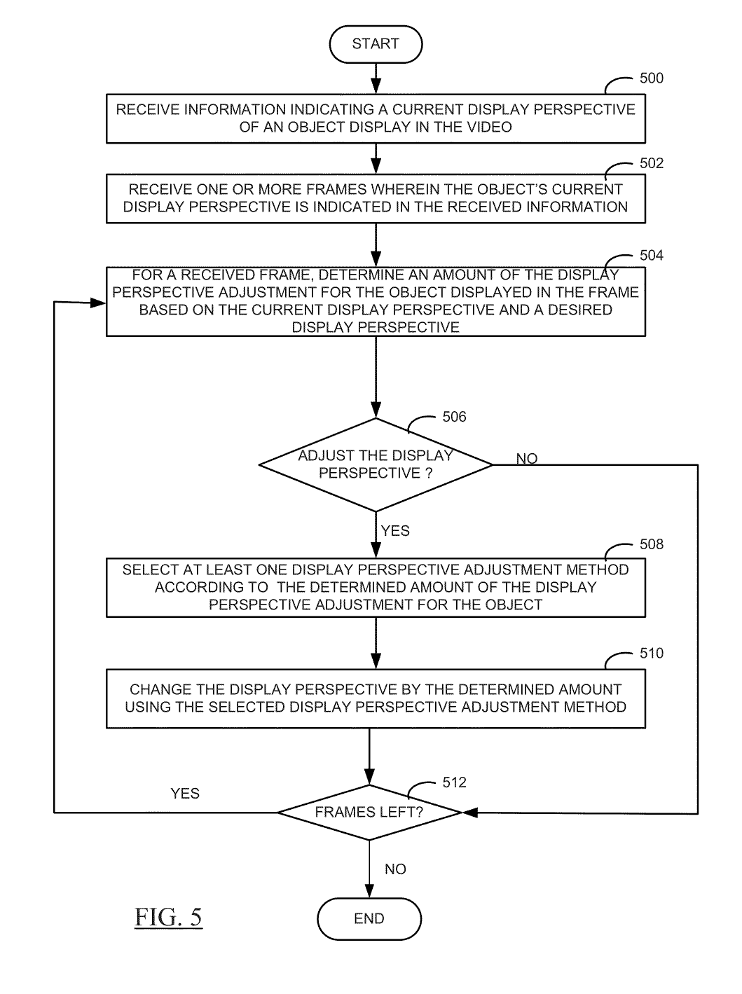

FIG. 3 illustrates one example of a method for changing a perspective of a video. It will be described with reference to FIGS. 1 and 2. However, any suitable structure may be employed. In operation, at block 300, the object detector 124 determines a displayed perspective for the object displayed in the video based on information indicating the orientation and/or position of the recording device, e.g., the recording device 130. At block 302, the perspective adjustment generator 120 changes the display perspective of the object displayed in the video using the graphics manipulator 122. The blocks 300 and 302 are further illustrated in FIGS. 4 and 5.

Referring to FIG. 4, in operation, at block 400, the object detector 124 obtains information 214 indicating an orientation and/or position of a recording device, i.e. the recording device 130, that captured on a video one or more objects whose perspective need to be changed. The information 214 may be received from the recording device 130, which may be equipped with one or more sensors capable of detecting its own orientation and/or position in a 3-D space with respect to one or more objects captured by the recording device 130. The recording device 130 may communicate the detected information 214 to the object detector 124 via suitable connections such as the connection 128. As noted above, the recording device 130 may also embed the detected information 214 as metadata 202 in the video and store the information 214 along with other frames of the video in the frame buffer 108. In that case, the object detector may retrieve the information 214 by extracting the metadata 202 from the frames received from the frame buffer 108 via a suitable connection such as the system bus 126. In some other examples, the information 214 may also be received from a remote sources cognizant of the orientation and/or position of the recording device 130 with respect to one or more objects captured on the video by the recording device 130, such as but not limited to, location detectors, cellular tower, remote computer server, data center, control station, to name a few. For example, one or more location detectors may be configured to detect a relative location between the recording device and an object which is identified as the object of interest according to the configuration information 218.

As noted above, the information 214 may indicate an orientation in the 3-D space with respect to a reference point using, e.g., polar coordinates (r,θ,φ), whereby r is the distance between the recording device 130 and the reference point, θ is the polar angle indicating degrees of inclination of the recording device relative to the reference point, and φ is the anzimuthal angle between the recording device and the reference point. The reference point may be the center of the video or another object captured by the recording device 130. In some other examples, the reference point may be any point that the object detector 124 can integrate into the image analysis for obtaining a current display perspective of the object of interest in the video. Additionally, the information 214 may also include a position of the recording device 130 in the 3-D space with respect to the reference point using, e.g., Cartesian coordinates (x,y,z).

At block 402, the object detector 124 receives one or more frames whose perspective needing to be changed. The object detector 124 may receive the frames of the video from a suitable storage, for example, frame buffer 108 or directly from a recording device, e.g. the recording device 130, via a suitable connection such as the connection 128.

At block 404, for a received frame, the object detector 124 detects the presence of an object of interest in the frame. As noted above, the object detector 124 may receive identification information of the object of interest from, e.g., the configuration information 208 stored in the configuration file 218. The identification information of the object may describe a type of object class, e.g., the face of a presenter, the patient's arm, license plate of a car, or any other suitable description that can facilitate a detection of an object in an image using image analysis method as generally known in the art. In some other examples, the identification of an object class may be pre-determined rules configured into the object detector 124 without being input from configuration information external to the object detector 124, i.e. the object detector 124 may be specialized to detect the position and/or orientation of a particular object class.

Based on the obtained information 214 regarding the orientation and/or position of the recording device 130, the object detector 124 is operative to detect a presence of the object of interest in each of received frames whose perspective needing to be changed. The object detector 124 may perform this operation using image analysis methods as generally known in the art capable of detecting an object in an image. For example, in one embodiment according to the disclosure, the object detector 124 is configured to detect a position of a presenter in a video and is configured to do so using one or more facial recognition methods as generally known in the art. In that embodiment, the object detector 124 may determine an eye level of the presenter with respect to a reference point, e.g. the center of the frame wherein the presenter is displayed.

At block 405, the object detector 124 recognizes whether the object of interest is detected in each received frame. In one embodiment according to the disclosure, the object detector 124 recognizes that the object of interest is detected in the received frame and proceeds to block 406. At block 406, the object detector 124 determines an orientation and/or position of the object of interest displayed in frame based on the obtained information 214 indicating an orientation and position of the recording device, e.g. recording device 130, that capture the object on the frame. For example, the object detector 124 may determine the object's orientation using polar coordinates of (r,θ,φ) with respect to a reference point in the frame, whereby r is the distance between the reference point and the object in the frame, θ is the object's inclination with respect to the reference point and φ is the anzimuthal angle between the object and the reference point. In one embodiment in accordance with the disclosure, the object detector 124 uses one or more facial recognition methods as generally known in the art to detect the presenter's eye level with respect to the center of the frame based on the information 214 regarding the orientation of the recording device 130 that captured the video. Accordingly, the object detector 124 generates information 204 indicating the object's orientation and/or position with respect to a reference point in the frame. The generated information 204 may be stored in a system memory such as the memory 106 for each received frame or may be communicated to the perspective generator 120 for further processing of the received frame via a suitable connection such as the system bus 126.

At block 408, the object detector 124 checks whether there is more received frame left to be processed by the object detector. In one embodiment according to the disclosure, the object detector 124 recognizes one or more received frames are yet to be processed, i.e. the information 204 indicating the object's orientation and/or position in those frames are yet to be generated. In that case, the object detector 124 proceeds to block 404 and repeats the processing described above. This processing for each received frame repeats until information 204 for the object's orientation and/or position in each of the received frames is generated.

Although the processing blocks illustrated in FIG. 4 are illustrated in a particular order, those having ordinary skill in the art will appreciate that the processing can be performed in different orders. In one example, the block 400 and 402 may be performed essentially simultaneously. The object detector 124 may receive frames and the information 214 indicating the orientation and/or position of the recording device at the same time, e.g. the information 214 is embedded in the video as metadata data 202.

Referring to FIG. 5, at block 500, the perspective adjustment generator 120 receives information 214 indicating a current display perspective of the object displayed in the video. In this example, the current display perspective of the object is the information 214 generated by the object detector 124, i.e. the orientation and/or position of the object in one or more frames in the video. As noted above, the perspective adjustment generator 120 may receive the information 214 via system storage such as the system memory 106, wherein the information 214 is stored. The perspective adjustment generator 120 may also receive the information 214 from the object detector 124 via a suitable connection such as the system bus 126.

At block 502, the perspective adjustment generator 120 receives the frames wherein the current display perspective of the object displayed in the video, e.g. the information 214 indicating the orientation and/or position of the object in one or more frames in the video, from the frame buffer 108. At block 504, for a received frame, the perspective adjustment generator 120 determines an amount of display perspective adjustment to be made for the object in the frame based on the current display perspective of the object, e.g. the information 214 indicating the orientation and/or position of the object with respect to a reference point in the frame, and a desired display perspective for the object in the video. As noted above, such a desired display perspective may be specified in configuration information 208 stored in the configuration file 218. In addition, the configuration information 208 may also be input by a user during run-time, i.e. when the video is presented on a display system. The desired display perspective may also be configured into the perspective adjustment generator 120 as predefined rules such that the perspective adjustment generator 120 becomes a specialized perspective adjustment generator. For example, in one embodiment in accordance with the disclosure, the perspective adjustment generator is configured to adjust a perspective of a video of a presenter, e.g. a video for a conferencing application, according to a naturalistic view of the presenter. In a naturalistic view of a presenter in the video, the presenter looks generally natural with an eye level as if the presenter was looking at one or more perceiving parties of the video.

Based on the desired display perspective for the object to be displayed in the video, the perspective adjustment generator 120 determines an amount of display perspective adjustment to be made to the current display perspective of the object in the frame. For each frame wherein the object's current display perspective is indicated by the information 214 generated by the object detector 124, the perspective adjustment generator 120 reads the information 214 and determines an amount of display perspective to be made by comparing the current display perspective with the desired display perspective for the object as configured. For example, the desired display perspective for the object, as configured, may specify that the object should be displayed upright with respect to the center of the video. The information 214 may indicate that the current display perspective of the object displayed in the frame is that its orientation is 45 degree counterclockwise with respect to the center of the frame on the X-Y panel. Accordingly, the perspective generator 120 determines that the object should be rotated 45 degree clockwise about the center of the frame. The information 214 may also indicate that the object is 5 centimeters directly under the center of the frame. The perspective adjustment generator 120 determines that the object also needs to be shifted up by 5 centimeters to the center of the frame. The information 214 may still indicate that the object's orientation has a 30 degree angle horizontally with respect to the center of the frame. Accordingly, the perspective adjustment generator 120 then determines the object needs to be rotated by −30 degree along horizontally on the Z-axis. Accordingly, the perspective adjustment generator 120, based on the information 214 and the configured desired display perspective, determines that the object displayed in the frame needs to be rotated −45 degree about the center on the X-Y plane and −30 degree horizontally along the Z-axis, and shifted up by 5 centimeters to the center of the frame.

At block 506, the perspective generator 120 recognizes whether there is an amount of display perspective adjustment to be made for the object as determined. In one embodiment in accordance with the disclosure, the perspective generator 120 recognizes that there is a determined amount of display perspective adjustment to be made for the object in the frame, and proceeds to block 508. At block 508, the perspective adjustment generator 106 selects one or more display perspective adjustment methods according to the determined amount of display perspective adjustment for the object. For example, according to the amount of display perspective adjustment of rotating the object −45 degree about the center on the X-Y plane and −30 degree horizontally along the Z-axis in the frame, and shifting the object up by 5 centimeters to the center of the frame in the frame, the perspective generator 120 selects affine operation to rotate the object on the X-Y plane for −45 degree and −30 degree on the X-Z plane. The perspective generator 120 in this case may also select a translation operation to move the object up for 5 centimeters in the frame.

At block 510, the graphics manipulator 122 changes the display perspective of the object at the instruction the perspective adjustment generator 120. As noted above, the perspective adjustment generator 120 communicates the determined amount of display perspective adjustment for the object in the frame, i.e. the information 210, as well as the information indicating one or more selected perspective adjustment methods to the graphics manipulator 122. Based on the information 210, the graphics manipulator 122 manipulates the image of the frame using the selected perspective adjustment methods. For example, to rotate the object by −45 degrees about the center using an affine operation, the graphics manipulator applies the affine operation to every pixel in the image of the frame and rotates the pixel from an original position to a destination position according to the amount of rotation that will rotate the object by −45 degrees. The graphics manipulator 122 then stores the transformed frame in the frame buffer 108 for further processing of the frame by the GPU.

At block 512, the perspective adjustment generator 120 recognizes whether there is received frame whose display perspective of the object is still to be changed. In one embodiment in accordance with the disclosure, the perspective adjustment generator 106 recognizes that there are still frames left to be processed and repeat the block 504 and so on. This processing repeats until there is no received frame whose perspective is still to be transformed.

Although the processing blocks illustrated in FIG. 5 are illustrated in a particular order, those having ordinary skill in the art will appreciate that the processing can be performed in different orders. In one example, blocks 504-508 and 510 may be performed essentially simultaneously. The perspective adjustment generator 120 may determine the amount of perspective adjustment for the next received frame at the same time when the graphics manipulator 122 manipulates the image of the current received frame.

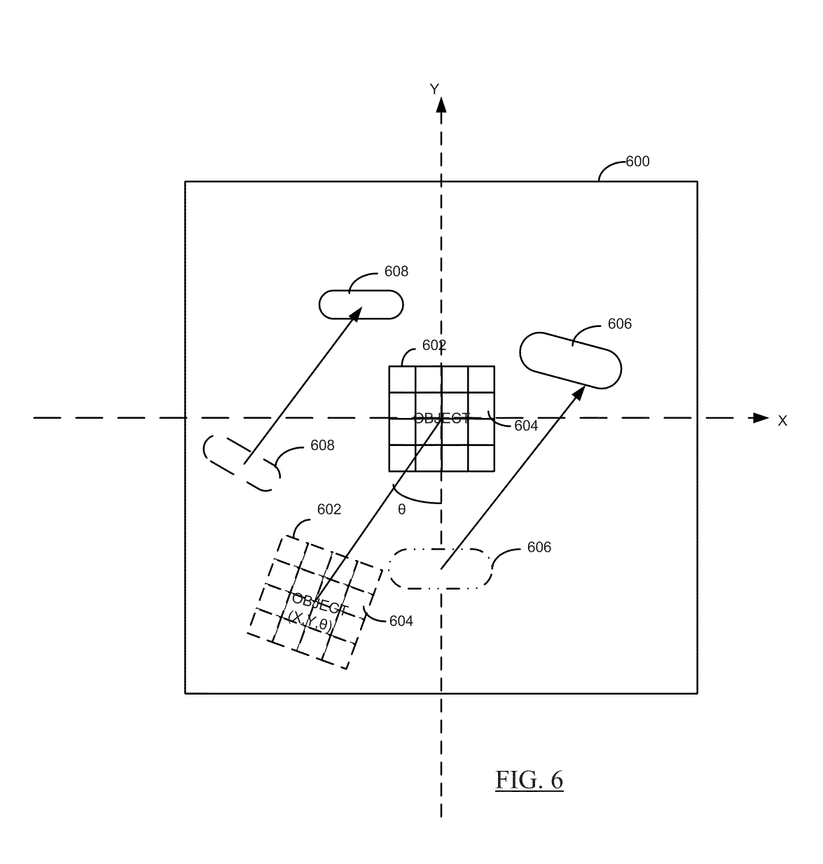

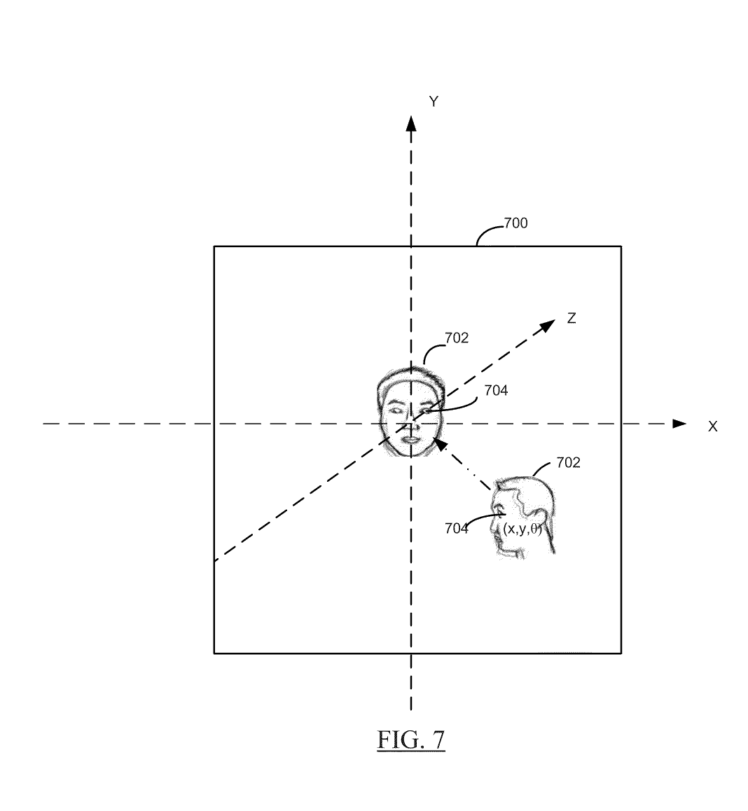

FIGS. 6-7 are illustrations of exemplary embodiments in accordance with the disclosure. FIG. 6 illustrates an example of changing a perspective of video by rotating an object displayed in the video for θ degrees counterclockwise about the center of the object 602 and moving the object 602 displayed in the video 600 to the center of the video. As shown in this example, an object of interest 602 is displayed in the video 600 along with other two objects, 606 and 608. The configuration information 208 stored in the configuration file 214, in this example, indentifies that the object 602's display perspective in the video should conform to a desired display perspective, i.e. displayed at the center of the video upright. Accordingly, the object detector 124 detects that the object 602 is present in one or more received frames of the video 600. The object detector 124 further obtains the information 214 indicating the orientation and position of the recording device that captured the video 600. Based on the information 214, for each received frame, the object detector 124 determines that the object 602 is displayed at a position of (x,y,θ) with respect to the center of the video 600. The object detector 124 communicates this current display perspective information 204 to the perspective adjustment generator 120.

At frame level, the perspective adjustment generator 120 receives the information 204 and compares the current display perspective for the object 602 indicated by the information 204 with the desired display perspective for the object 602 as configured, e.g. in the configuration file 208. In so comparing, for each frame, the perspective adjustment generator 120 may determine that the object 602 displayed in the video 600 needs to be moved towards the center of the video 600 from the current position (x,y) and needs to be rotated by −θ degree about the center of the object 602.

According to the determined amount of display perspective adjustment to be made for the object 602 displayed in the video 600, the perspective adjustment generator 120 further selects that an affine operation and translation operation to carry out the determined amount of display perspective adjustment for the object 602. The perspective adjustment generator 120 may make such selections based on the configuration information 208 stored in the configuration file 214. For example, the configuration information 208 may configure the perspective adjustment generator 124 not to adjust the display perspective for the object 602 in the video 600 by using any interpolation or scaling operations. Accordingly, the perspective adjustment generator 124 will not select one or more of those methods to carry out the determined amount of perspective adjustment for the object 602.

Based on the determined amount of display perspective adjustment for the object 602 displayed in the video 600 and selected perspective adjustment methods for carrying out such an adjustment, the perspective adjustment generator 120, in this example, generates one or more control commands 216 instructing the graphics manipulator 122 to change the perspective of the video 600 accordingly. The graphics manipulator 122 receives the control commands 216 and for each frame whose perspective needing to be changed according to the information 210 indicating the determined amount of perspective adjustment generated by the perspective adjustment generator 120, the graphics manipulator 122 changes the display perspective for the object 602 displayed in the video 600. In this example, the graphics manipulator determines that the pixels comprising the object 602 in each such frame, e.g. the pixel 604, need to be moved by a distance of r towards the center of the video, whereby r is the square root of x²+y² using a translation operation. The graphics manipulator 122 also determines that these pixels need to be shifted from an original position in the video 600 to a destination position using the affine operation such that the object is rotated by θ degrees clockwise about the center of the object 602. In addition, the graphics manipulator 122 also perform these operations for other pixels in the frame, e.g. pixels comprising objects 606 and 608, so the perspective of the video looks correct after the display perspective of the object 602 is changed in the video 600.

FIG. 7 illustrates one example of changing a perspective of a video by transforming a presenter's perspective displayed in a video. As shown in this example, a presenter 702 was displayed in video 700 with an original display perspective such that the presenter's eye level 704 is captured at a position (x,y) on the video with respect to the center of the video. In addition, in original display perspective, the right side of the presenter 702 is fully exposed, but not the front side. In this example, the object detector 124 obtains the information 214 regarding the position and orientation of the recording device that captured the video 700. The object detector 124 also employs one or more facial recognition methods as generally known in the art to detect the presence of the presenter 702's face as well as the eye level 704. In so detecting, the object detector 124 obtains a position and orientation of the presenter's face as displayed in the video 700 based on the orientation and position information 214 regarding the recording device, e.g. the relative Cartesian location between the recording device and the presenter. In this example, base on the information 214, the object detector 124 may employ a facial recognition method to determine that presenter's eye level is the located position (x,y) with respect to the center of the video captured by the recording device 130 and the presenter's face is at 90 degree along the X-Z plane about the center of the video. The object detector 124 communicates this information, i.e. the information 204 indicating the presenter 702's current display perspective in the video 700, to the perspective adjustment generator 120.

The perspective adjustment generator 120 receives the information 204 regarding the presenter 702's current display perspective in the video. In this example, the perspective adjustment generator 120 is configured according the configuration information 218 to adjust the display perspective of the presenter 702 in the video conforming to a naturalistic view of the presenter 702, i.e. the presenter's face should be displayed at the center of the video and the presenter's eye level should be at parallel to the Z-axis. Accordingly, the perspective adjustment generator 120 determines that the presenter's face as well as eye level 704 displayed in the video 700 needs to be moved to the center of the video 700 from the current position (x,y) and needs to be rotated by −90 degree about the center of the video. The perspective adjustment generator 124 also determines some part of the front side of the presenter 702 should be reconstructed, for example, based on one or more images of the presenter 702 in the video that the front side of the presenter's face has been captured and displayed.

According to the determined amount of display perspective adjustment to be made for the presenter 702 displayed in the video 700, the perspective adjustment generator 120 further selects an rotating operation and shifting operation to rotate and move the position of presenter's face displayed in the video 700. The perspective adjustment generator 120 also selects a historical reconstruction method to reconstruct the front side of the presenter's face to be displayed in the transformed video.

Based on the determined amount of display perspective adjustment for the presenter 702 displayed in the video 700 and selected perspective adjustment methods for carrying out such an adjustment, the perspective adjustment generator 120, in this example, generates one or more control commands 216 instructing the graphics manipulator 122 to change the perspective of the video 700 accordingly. The graphics manipulator 122 receives the control commands 216 and for each frame whose perspective needing to be changed according to the information 210 indicating the determined amount of perspective adjustment generated by the perspective adjustment generator 120, the graphics manipulator 122 changes the display perspective for the presenter 702 displayed in the video 700. In this example, the graphics manipulator 122 determines that the pixels composing the presenter 702 in each such frame need to be moved by a distance of r towards the center of the video, whereby r is the square root of x²+y², using a shifting operation. The graphics manipulator 122 also determines that these pixels also need to be rotated from an original position in the video 700 to a destination position using an rotating operation such that the presenter's face is rotated by 90 degree on the X-Z plane about the center of video 700. In addition, the graphic manipulator 122 also reconstructs missing pixels of the presenter's front side of the face for each such frame so the whole front side of the presenter's face will be exposed in the transformed video.

Among other advantages, for example, the method and apparatus provides the ability to change a perspective of a video automatically according to a desired display perspective for one or more objects displayed in the video without user's intervention. Instead of requiring the user to determine a current display perspective of the object displayed in the video, an amount of display perspective adjustment to be made for the object in the video based on the current display perspective of the object and manually carry out the display perspective adjustment in the video, the method and apparatus changes the display perspective of the object automatically conforming to a desired display perspective for the object as defined with very little user interaction, thereby improving user's experience in viewing and using the video for various purposes, e.g. communication, medical diagnosis, security, etc. Accordingly, the proposed techniques can improve user experience in video viewing by providing an automatic way to adjust a perspective of the video, wherein one or more objects of interest are displayed, to a desired perspective according to the purpose of the viewing. Other advantages will be recognized by those of ordinary skill in the art.

The above detailed description of the invention and the examples described therein have been presented for the purposes of illustration and description only and not by limitation. It is therefore contemplated that the present invention covers any and all modifications, variations or equivalents that fall within the spirit and scope of the basic underlying principles disclosed above and claimed herein.

What is claimed is:

1. A method, carried out by one or more apparatus, for changing a perspective of a video, the method comprising:
changing a display perspective of an object displayed in the video based on information indicating an orientation and/or position of a recording device that captured the object on the video.

2. The method of claim 1 further comprising:
determining a display perspective for an object displayed in the video based on information indicating an orientation and/or position of the recording device that captured the object on the video.

3. The method of claim 3, wherein changing the display perspective of the object comprises:
determining an amount of display perspective adjustment for the object displayed in the video;
selecting at least one display perspective adjustment method according to the determined amount of display perspective adjustment for the object; and
changing the display perspective of the object displayed in the video using the selected at least one display perspective adjustment method.

4. The method of claim 3, wherein determining an amount of display perspective adjustment for the object is further based on configuration information that indicates at least one property of perspective adjustment to be made.

5. The method of claim 4, wherein configuring at least one property of perspective adjustment to be made comprises at least one of the following:
identifying an object class whose display perspective may be adjusted in the video; and
changing the display perspective for the object class.

6. The method of claim 3, wherein the selecting at least one display perspective adjustment method comprises selecting at least one of the following:
at least one graphics geometric manipulation method; and
at least one object reconstruction method.

7. The method of claim 2, wherein determining a display perspective of the object displayed in the video based on information indicating the orientation and/or position of the recording device comprises:
obtaining information indicating the orientation and/or the position of recording device; and
determining a position and/or orientation of the object displayed in the video captured by the recording device based on the obtained information indicating the orientation and/or position of the recording device.

8. The method of claim 7, wherein the object is a face in the video and wherein obtaining the position of the face in the video comprises detecting the face using at least one facial recognition method.

9. The method of claim 7 further comprising embedding the information of indicating orientation and/or position of the recording device in the video as metadata.

10. The method of claim 7, wherein the information indicating the orientation and/or the position of the recording device is obtained by extracting metadata from the video.

11. An apparatus for changing a perspective of a video, the apparatus comprising:
video perspective adjustment logic configured to:
change a display perspective of an object displayed in the video based on information indicating an orientation and/or position of the recording device that captured the object on the video.

12. The apparatus of claim 11 further comprising:
object detection logic configured to:
determine a display perspective for an object displayed in the video based on information indicating an orientation and/or position of the recording device that captured the object on the video.

13. The apparatus of claim 12, wherein changing the display perspective of the object comprises:
determining an amount of display perspective adjustment for the object displayed in the video;
selecting at least one display perspective adjustment method according to the determined amount of display perspective adjustment for the object; and
changing the display perspective of the object displayed in the video using the selected at least one display perspective adjustment method.

14. The apparatus of claim 13, wherein determining an amount of display perspective adjustment for the object is further based on configuration information that indicates at least one property of perspective adjustment to be made.

15. The method of claim 14, wherein configuring at least one property of perspective adjustment to be made comprises at least one of the following:
identifying an object class whose display perspective may be adjusted in the video; and
changing the display perspective for the object class.

16. The apparatus of claim 13, wherein the selecting at least one display perspective adjustment method comprises selecting at least one of the following:
at least one graphics geometric manipulation method; and
at least one object reconstruction method.

17. The apparatus of claim 12, wherein determining a display perspective of the object displayed in the video based on information indicating the orientation and/or position of the recording device comprises:
obtaining information indicating the orientation and/or the position of the recording device; and
determining a position and/or orientation of the object displayed in the video captured by the recording device based on the obtained information indicating the orientation and/or the position of recording device.

18. The apparatus of claim 17, wherein the object is a face in the video and wherein obtaining the position of the face in the video comprises detecting the face of the presenter using at least one facial recognition method.

19. The apparatus of claim 12 further comprising:
at least one recording device, operatively coupled to the object detection logic and perspective adjustment logic, that is operative to capture the object on the video; and
at least one display device operative to display the video.

20. The apparatus of claim 17, wherein the recording device is further operative to embed the orientation information of the recording device in the video as metadata.

21. The apparatus of claim 17, wherein the information indicating the orientation and/or the position of the recording device is obtained by extracting metadata from the video.

22. A non-transitory computer readable medium comprising executable instructions that when executed by one or more processors causes the processor to:
change a display perspective of an object displayed in the video based on information indicating an orientation and/or position of the recording device that captures the object on the video.

23. The non-transitory computer readable medium of claim 22 further comprising executable instructions that when executed by one or more processors causes the processor to:
determine a display perspective for an object displayed in the video based on information indicating an orientation and/or position of the recording device that captures the object on the video.

24. The non-transitory computer readable medium of claim 23, wherein changing the display perspective of the object comprises:
determining an amount of display perspective adjustment for the object displayed in the video;
selecting at least one display perspective adjustment method according to the determined amount of display perspective adjustment for the object; and
changing the display perspective of the object displayed in the video using the selected at least one display perspective adjustment method.

25. The non-transitory computer readable medium of claim 24, wherein determining an amount of display perspective adjustment for the object is further based on configuration information that indicates at least one property of perspective adjustment to be made.

26. The non-transitory computer readable medium of claim of 25, wherein configuring at least one property of perspective adjustment to be made comprises at least one of the following:
identifying an object class whose display perspective may be adjusted in the video; and
changing a desired display perspective for the object class.

27. The non-transitory computer readable medium of claim 24, wherein the selecting at least one display perspective adjustment method comprises selecting at least one of the following:
at least one graphics geometric manipulation method; and
at least one object reconstruction method.

28. The non-transitory computer readable medium of claim 24, wherein determining a current perspective of the object displayed in the video based on information indicating the orientation and/or position of the recording device comprises:
obtaining information indicating the orientation and/or the position of recording device;
determining a position and/or orientation of the object displayed in the video captured by the recording device based on the obtained information indicating the orientation and/or the position of recording device.

29. The non-transitory computer readable medium of claim 28, wherein the object is a presenter's face in the video and wherein obtaining the position of the presenter face in the video comprises detecting the face of the presenter using at least one facial recognition method.

30. The non-transitory computer readable medium of claim 24, wherein the executable instructions that when executed by one or more processors further causes the processor to embed the orientation information of the recording device in the video as metadata.

31. A non-transitory computer readable medium comprising data defining one or more video streams and executable instructions that when executed by one or more processors causes the processor to:
generate one or more videos for display based on the data defining the video streams, wherein the videos comprise at least one adjusted display perspective of one or more objects captured in the video streams.

32. The non-transitory computer readable medium of 31, wherein the adjusting of the perspective of the one or more objects captured in the video streams comprises:
determine a display perspective for the objects in the video streams based on information indicating an orientation and/or position of a recording device that captured the objects in the video streams.

33. The non-transitory computer readable medium of 31, wherein the adjusting of the perspective of the one or more objects captured in the video streams further comprises:
determining an amount of display perspective adjustment for the objects captured in the video stream;
selecting at least one display perspective adjustment method according to the determined amount of display perspective adjustment for the objects; and
changing the display perspective of the objects using the selected at least one display perspective adjustment method.

34. A non-transitory computer readable medium comprising executable instructions that when executed by one or more processors causes the processor to:
generate an adjusted perspective for an object for display based on metadata embedded in one or more videos having the object;
The non-transitory computer readable medium of claim 34, wherein the metadata comprises information indicating an orientation and/or position of a recording device that captured the object on the videos.
